(19) United States
(12) Patent Application Publication
(10) Pub. No.: US 2002/0113998 A1
(43) Pub. Date: Aug. 22, 2002

(54) Print system

(76) Inventor: Osamu Fujinawa, Niigata (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/073,964

(22) Filed: Feb. 14, 2002

(30) Foreign Application Priority Data
Feb. 19, 2001 (JP) 041281/2001

(51) Int. Cl. G06F 15/00

(52) U.S. Cl. 358/1.15

(57) ABSTRACT

A print system including a printer device and a host for providing contents. The printer device has a printer ID and a nonvolatile memory to hold a delivery request information table for storing access destination addresses and specific information about the printer device such as the printer ID. The printer device executes a delivery request of the contents by sending the table to the host and receives print data of the contents from the host to print the print data. The host receives the table from the printer device, determines whether the contents should be delivered according to the printer ID included in the received table, produces the print data of the contents on the basis of the specific information about the printer device, and delivers the print data to the printer device. By this structure, the printer device or a delivery request terminal voluntarily connects to the host at predetermined time or predetermined cycle to obtain designated contents to be printed. When the accessed contents are charged, duplication and illegal acquirement of contents can be effectively prevented.

### BACKGROUND OF THE INVENTION

The present invention relates to a print system in which a printer voluntarily connects to a host at a predetermined time to obtain contents or information from the host and prints the contents by the printer on the basis of set information of a user, and more particularly, to a print system including a host which determines whether requested contents should be delivered depending on an identification (ID) of a printer.

### DESCRIPTION OF THE PRIOR ART

In recent years, personal computers (PCs) connected to a network have come into widespread use. Therefore, today, documents that have been conventionally distributed in paper can be displayed and read on a screen of a PC. However, newspapers, leaflets, magazines and the like are still printed on paper for distribution.

When the documents are read on the screen of a PC, from the nature of the display screen, fatigue can be caused on the eyes of a viewer as compared with the case of reading a surface of a sheet of paper. Furthermore, because the size of a display screen is limited, such display screen may be less convenient when compared with the convenience of reading the documents printed on the paper.

In particular, color printed matters typically represented by leaflets inserted in daily newspapers, for instance, are vivid and are naturally caught by the consumers' eyes every morning with a result of raising a large advertising effect contributed by the nature of the paper.

For the aforementioned reasons, even if the network is further developed in the future, it is conceivable that the information delivery by paper becomes increasingly important.

The information delivery by paper such as the above-mentioned leaflets inserted in daily newspapers is carried out mainly for the limited neighboring residents. This is based on a premise that the consumers buy goods from stores near their houses.

However, along with the spread of the consumers' acting area nowadays, people do not always buy goods only around their houses. For example, when a person works in an office next town, he/she may do shopping in a store next town on his/her way home.

However, leaflets inserted in newspapers in the next town are limitedly distributed to the residents in that town, and there is less chance that the leaflets are viewed by consumers commuting from different towns. Hence, in such information delivery method, certain information is available to people at limited area.

Further, the conventional information delivery by paper may cover all neighboring households, but a fruitless action such as distributing leaflets of child care goods to single households is conducted most commonly.

Such things happen because area research is not sufficient due to its large cost, for instance, and the situation of the neighboring households cannot be grasped. As a result, such information delivery method involves a lot of wastes and is very poor in terms of its advertising efficiency.

Now, information which have conventionally been obtained through leaflets inserted in newspapers, for example, can be obtained by connecting to the Internet and downloading the information. In addition, the downloaded data can be printed out and obtained as a paper advertisement.

However, in order to obtain information by this method, the user must turn on the PC, connect the PC to the Internet, access a target home page, download the information and print it out on paper.

Hence, it is necessary for the user to secure his/her time for such manual operation, and besides it is difficult to execute such manual operation constantly in a daily life. This can be noted as a first problem.

Further, in conventional cases, when predetermined contents are printed by a printer, usually, the contents are downloaded to the PC in the first place and then sent to the printer for printing.

In this method, however, when the contents are downloaded, the contents are to be once stored in a storage device of the PC, and thus there is a possibility that a copy of the contents is made. In order to prevent such duplication of contents, a particular password (a composite key) may be given. In this case, however, a problem of controlling the password arises. This is because the password itself can be stolen and duplicated in the same manner.

Under such circumstances, when the contents to be printed are charged, a particular method is required for preventing invalid acquirement of the contents by duplication or the like. This can be noted as a second problem.

Therefore, in the prior art, in order to print the contents, the user must access the target contents using the PC and download the contents, and when the contents to be printed are charged, a countermeasure against duplication of the contents is required. That is, the conventional print system has not resolved the first and the second problems.

### SUMMARY OF THE INVENTION

It is therefore an object of the present invention to provide a print system in view of the aforementioned problems in the prior art, in which either a printer device or a delivery request terminal voluntarily connects to a host periodically at a predetermined time to obtain prescribed contents from the host and prints the contents, and which is capable of preventing duplication and invalid acquirement of contents when the obtained contents are charged.

In accordance with one aspect of the present invention, there is provided a print system including a printer device and a host connected to the printer device for providing contents to the printer device, the printer device provided with a printer identification, including a nonvolatile memory holding a delivery request information table storing access destination addresses and specific information about the printer device including the printer identification, executing a delivery request of the contents to the host by sending the delivery request information table to the host, and receiving print data of the contents from the host to print the print data, the host receiving the delivery request information table from the printer device, determining whether the requested contents should be delivered according to the printer identification included in the received delivery request information table, producing the print data of the contents on the basis of the specific information about the printer device, and delivering the print data to the printer device.

In the print system of the present invention, the printer device further includes a timer and the delivery request information table further stores an access time and an access period. When the timer clocks the access time and the access period stored in the delivery request information table, the printer device accesses the access destination address and requests the host to deliver the contents.

In the print system of the present invention, the printer device further includes a delivery request means, and when the delivery request means inputs the delivery request, the printer device accesses the access destination address and requests the host to deliver the contents.

In accordance with another aspect of the present invention, there is provided a print system including a printer device, a host providing contents, and a delivery request terminal connected in between the printer device and the host, the delivery request terminal provided with a delivery request terminal identification, including a nonvolatile memory holding a delivery request information table storing access destination addresses, the delivery request terminal identification and specific information about the printer device, executing a delivery request of the contents by sending the delivery request information table to the host, and receiving print data of the contents from the host to send the print data to the printer device, the printer device printing the received print data, the host receiving the delivery request information table from the delivery request terminal, determining whether the requested contents should be delivered according to the delivery request terminal identification included in the received delivery request information table, producing the print data of the contents on the basis of the specific information about the printer device, and delivering the print data to the delivery request terminal.

In the print system of the present invention, the delivery request terminal further includes a timer and the delivery request information table further stores an access time and an access period. When the timer clocks the access time and the access period stored in the delivery request information table, the delivery request terminal accesses the access destination address and requests the host to deliver the contents.

In the print system of the present invention, the delivery request terminal further includes a delivery request means, and when the delivery request means inputs the delivery request, the delivery request terminal accesses the access destination address and requests the host to deliver the contents.

In the print system of the present invention, the host obtains the specific information about the printer device from the delivery request information table and delivers the contents according to the specific information to either the printer device or a delivery request terminal.

In the print system of the present invention, the host obtains information about a past record of the contents obtained by either the printer device or a delivery request terminal from the delivery request information table and controls either the printer device or the delivery request terminal so that the printer device can print the specified contents for a limited number of times.

In the print system of the present invention, the host separately controls charged and free contents according to the printer identification or a delivery request terminal identification, and when the contents requested for delivery are charged, a user is charged under either the printer identification or the delivery request terminal identification.

In the print system of the present invention, the printer device is a color ink-jet printer, a color laser printer, a monochrome laser printer or a dot impact printer capable of using copying paper.

### BRIEF DESCRIPTION OF THE DRAWINGS

The objects, features and advantages of the present invention will become more apparent from the consideration of the following detailed description, taken in conjunction with the accompanying drawings, in which:

FIG. 1 is a block diagram of a print system according to a first embodiment of the present invention;

FIG. 2 is a flow chart showing communications between a host and a printer device of the present invention;

FIG. 3 is a schematic view showing one example of a printer ID on a display in the print system of the present invention;

FIG. 4 is a flow chart showing procedures in an accounting process by the print system of the present invention;

FIG. 5 is a schematic view showing one example of contents of a delivery request information table used in the print system of the present invention;

FIG. 6 is a schematic view showing a console panel used in the print system of the preset invention;

FIG. 7 is a block diagram of a print system according to a second embodiment of the present invention; and

FIG. 8 is a block diagram of a print system according to a third embodiment of the present invention.

### DESCRIPTION OF THE PREFERRED EMBODIMENTS

Referring now to the drawings, the embodiments of the present invention will be described in detail.

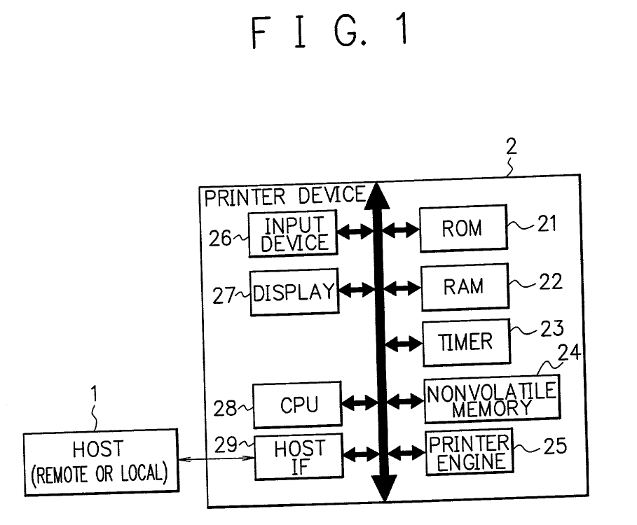

FIG. 1 shows a print system according to a first embodiment of the present invention. As shown in FIG. 1, the print system comprises a host 1 and a printer device 2. The host 1 provides contents to the printer device 2. The host 1 can be connected to the printer device 2 via a network (remote host connections) or can be directly connected to the printer device 2 (local host connection).

The printer device 2 includes a ROM (read only memory) 21 for storing a control program and data, a RAM (random access memory) 22 for holding a print image and exploiting as a work area, a timer 23 for counting the present time, a nonvolatile memory 24 for holding various information, which is electrically rewritable, a printer engine 25 for printing print data on a medium, an input device 26 for executing various settings, a display 27 for indicating the settings of the printer device 2 for confirmation, a CPU (central processing unit) 28 for controlling all the members of the printer device 2, and a host IF (interface) 29 for communicating with the host 1.

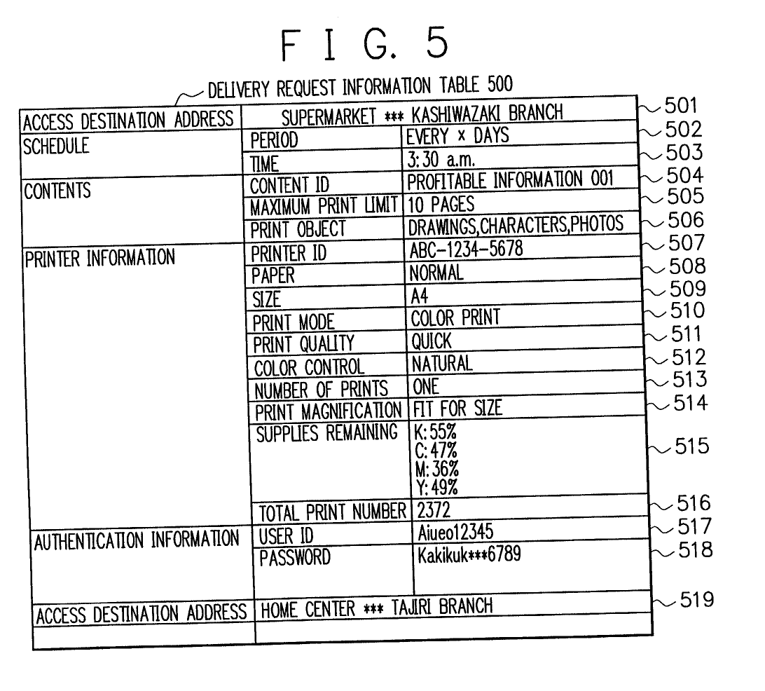

The nonvolatile memory 24 holds a delivery request information table 500 as shown in FIG. 5, which includes a printer ID (identification) 507. The printer ID is a specific number assigned to this printer device and is the one and only number in the world. The printer ID 507 is predetermined and a user can look up this information but cannot change it. For example, the printer ID 507 may be set when the printer device 2 is shipped from the factory. The other information can be set through the input device 26 etc. by the user.

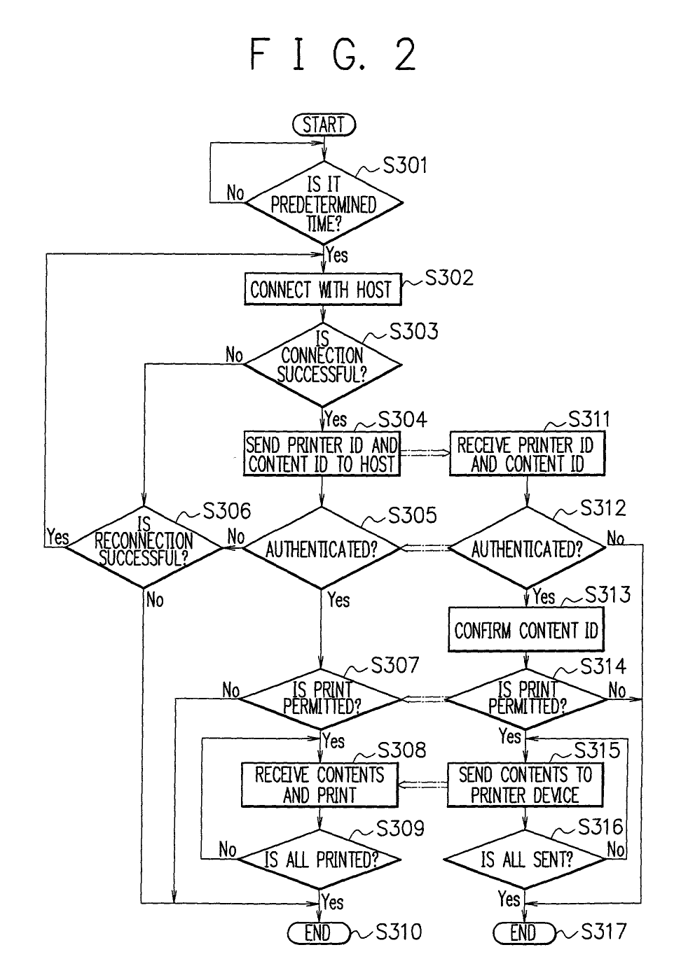

An operation of the print system shown in FIG. 1 will be described in detail with reference to FIG. 2 and FIG. 5.

FIG. 2 is a flow chart showing communications between the printer device 2 and the host 1. In FIG. 2, steps S301 to S310 show a processing flow on the printer device side, and steps S311 to S317 show a processing flow on the host side. Dashed lines between the two processing flows show the communications between the printer device 2 and the host 1.

In FIG. 5, details of the delivery request information table 500 are shown. The printer device 2 looks up this table 500 and requests the host to deliver the contents according to the information (setting) included in the table 500. At this time, all (or a part) of the contents of the delivery request information table 500 is sent to the host 1 being the delivery request destination.

First, the printer device 2 looks up a period 502 and a time 503 in the delivery request information table 500 shown in FIG. 5 and awaits a coming designated time (step S301). In this embodiment, the printer device 2 awaits 3:30 a.m. every day.

The delivery request information table 500 can store a plurality of delivery request information. For instance, the delivery request information table 500 of FIG. 5 includes access destination addresses 501 and 519, and in this case, one delivery request information is considered as corresponding to a set of information 501 to 518 shown in FIG. 5.

In case when there are a plurality of access destination addresses, by successively scanning the access destination addresses in the delivery request information table 500, one delivery request information can be specified. The following description will be given with respect to one access destination address.

At 3:30 a.m., the printer device 2 voluntarily starts accessing an access destination address “supermarket *** Kashiwazaki branch” 501 (step S302). This address is converted into a corresponding network address by a known method when accessing. Further, it can be considered that this address is stored together with other addresses under certain content such as a delivery information store list, in a particular area of a particular home page of a particular provider.

When the connection with the host is not successful by some reason (step S303/No), reconnection with the host is performed (step S306). When the reconnection with the host is not successful in step S306, the delivery of the contents is determined as a failure and the process is terminated (step S310).

When the connection with the host is successful (step S303/Yes), the printer device 2 sends the predetermined information such as a printer ID, a content ID and the like included in the delivery request information table 500 to the host 1 (step S304).

Each content is assigned with the content ID, and the user can obtain the content (information) designated by the access destination address 501 and the content ID 504.

In this embodiment, the access destination address 501 is the “supermarket *** Kashiwazaki branch” and the content ID 504 is “profitable information 001”. In this case, therefore, the user can obtain today's “profitable information 001” of the “supermarket *** Kashiwazaki branch”.

The host 1 receives the printer ID and the content ID from the printer device 2 (step S311) and carries out an authentication, that is, determines whether the user has an access right (step S312).

For example, it is also possible to determine or authenticate the user's access right by determining whether a user ID 517 and a password 518 are registered to the host 1.

When there is a problem in the authentication (step S312/No), the host 1 finishes the process (step S317). The result of authentication is also notified to the printer device 2 (step S305). Upon knowing the failure of the authentication, the printer device 2 determines whether reconnection with the host is successful (step S306).

When the authentication is given (step S312/Yes), the host 1 confirms the content ID 504 (step S313). This authentication is not always necessary. That is, it is sufficient as long as it is possible to confirm that the user has the access right. Here, it is assumed that the user attempts to connect with a particular provider by a dialup.

The host 1 then determines whether the printer device 2 should be allowed to print the contents identified by the content ID 504 (step S314). When the contents are free of charge, a print permission of the contents is unconditionally issued (step S314/Yes). On the other hand, when the contents are charged, the host looks up the accounting information on the printer ID 507.

In this case, it is assumed that the user makes payments under the name of the printer ID 507 in advance. The host 1 compares the cost of the contents with the balance, deducts the cost of the contents from the balance, makes the deduction result as a new balance, and issues the print permission (step S314/Yes). When the balance is short, the print permission will not be issued (step S314/No). In this way, the host 1 determines whether printing should be permitted, and terminates the process in case of not issuing the print permission (step S317).

In case of issuing the print permission (step S314/Yes), the host 1 sends the contents to the printer device 2 (step S315). For example, the host 1 produces the print data on the basis of the optimum printer driver selected from the printer ID and information such as a maximum print limit 505, a print object 506 and printer information 508 to 516 of the delivery request information table 500, and sends the produced print data to the printer device 2.

The maximum print limit 505 indicates the maximum number of printing pages for the designated contents. For instance, the maximum limit 505 is set to 10 pages in the delivery request information table 500 shown in FIG. 5. Hence, the content corresponding to the content ID 504 such as the “profitable information 001” shown in FIG. 5 is printed up to 10 pages at the most.

The print object 506 is a part of the contents to be printed, and more specifically, it can be drawings, characters, photos and so forth. Both the maximum print limit 505 and the print object 506 can be set optionally by the user.

Further, in this case, the host 1 is to send the print data to the printer device 2 after it produces the print data. As a result, in this embodiment, duplication of the contents can be prevented as compared to the conventional method in which contents to be printed are once stored in a storage of a PC (personal computer) and are then sent to a printer device which then produces print data.

The host 1 also informs the printer device 2 as to whether printing should be permitted (step S307). When printing is not permitted (step S307/No), the printer device 2 terminates the process (step S310). On the other hand, when printing is permitted (step S307/Yes), the printer device 2 receives the contents sent from the host 1 and prints out the contents (step S308).

The printing of the received contents is carried out by using the printer engine 25 as shown in FIG. 1. In the present invention, it is assumed that color documents are printed at home, and a color ink-jet printer as the printer engine 25 is most preferable. However, the present invention is not restricted to such printer.

Thereafter, in step S316, the host 1 awaits until the printer device 2 finishes printing all the print data (step S309/Yes), and when the printing is completed without any problem, both the host 1 and the printer device 2 finish their processes (steps S310 and S317).

Along with the above-mentioned process, the host 1 can provide service to users by giving some messages to the user ID 517, for example, a message for attracting attention to supplement of ink cartridges on the basis of a “supplies remaining” 515 and a message for calling attention to maintenance of the printer device on the basis of a “total print number” 516. In addition, on the basis of the user ID 517 and the content ID 504, it is possible to learn the user's preference tendency, which can be used for marketing.

Further, the host 1 can obtain the printer ID 507 and the past record of the obtained contents information. Hence, the host 1 can control the printer device 2 having a prescribed printer ID so that the printer device 2 may print only for a designated number of times. Accordingly, the provider of charged contents can effectively prevent illegal duplication of contents.

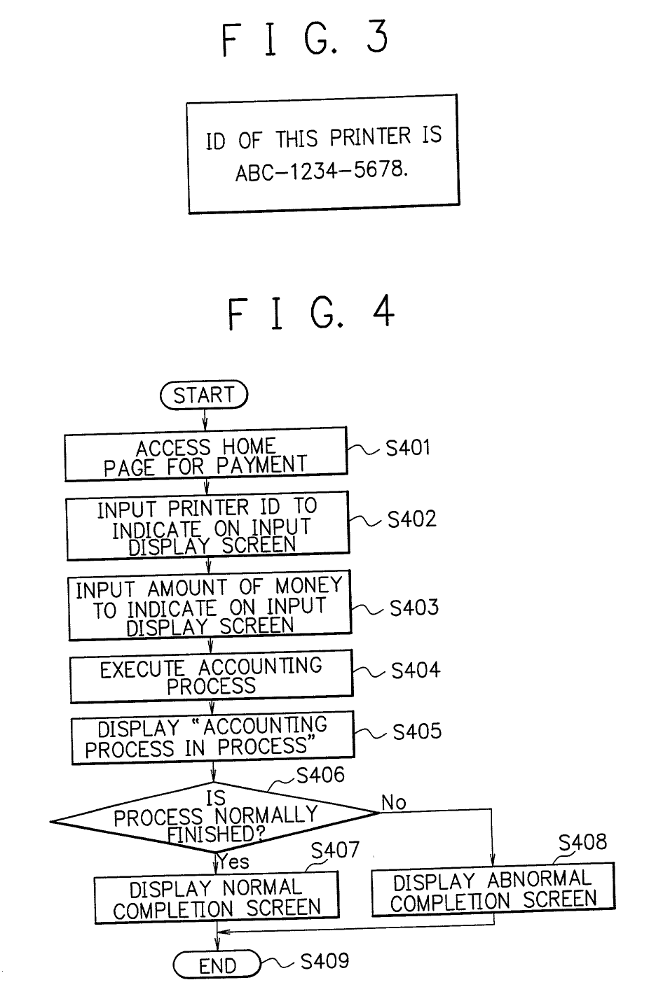

Now, an accounting process by a contents server will be described in detail with reference to FIGS. 3 and 4.

In the present invention, the printer device 2 possesses a specific printer ID, and information control including accounting process is carried out on the basis of the printer ID. Hence, it is required that the user knows the printer ID.

The user inputs a display instruction to the input device 26 of the printer device 2 in order to have the printer ID 507 displayed for confirmation. The display 27 then displays the printer ID 507, as shown in FIG. 3 so that the user can readily confirm the printer ID. It is desirable that this operation can be done easily.

For instance, the printer device 2 can be provided with a push-button type of printer ID display means, so that the printer ID can be displayed on the display 27 by pushing down the printer ID display button. Furthermore, by using the printer engine 25, the indication of the printer ID, as shown in FIG. 3, can be printed out on a recording medium such as a sheet of paper.

The user can perform the accounting process by using the printer ID obtained in this manner. FIG. 4 shows a flow chart of procedures in the accounting process.

First, the user accesses a home page for exclusive use for payment to execute a payment process (step S401). The user then inputs and indicates the printer ID 507 previously confirmed on an input display screen (step S402). Thereafter, the user inputs the amount of money for payment to indicate on the input display screen (step S403). For example, when newspaper is delivered every day for one month, the user inputs and indicates the necessary amount of money, such as 3,000 yen, for instance, on the input display screen.

The host 1 (contents server) then performs an accounting process (step S404). For instance, in this process, the user can select a payment method such as electronic money, a credit card or the like. The host 1 executes the process according to the selected payment method. The host 1 displays a notice such as “accounting process in process” on the display screen during the accounting process (step S405).

When the accounting process is correctly or normally completed (step S406/Yes), that is, for example, the process for purchasing 3,000 yen worth of contents under the printer ID 507 is completed, a screen for normal completion is displayed (step S407). On the other hand, when the accounting process is not normally completed (step S406/No), that is, for example, the validity period of the credit card has already expired and 3,000 yen is not available for payment, a screen for abnormal completion is displayed (step S408). In both cases, the process is then terminated (step S409).

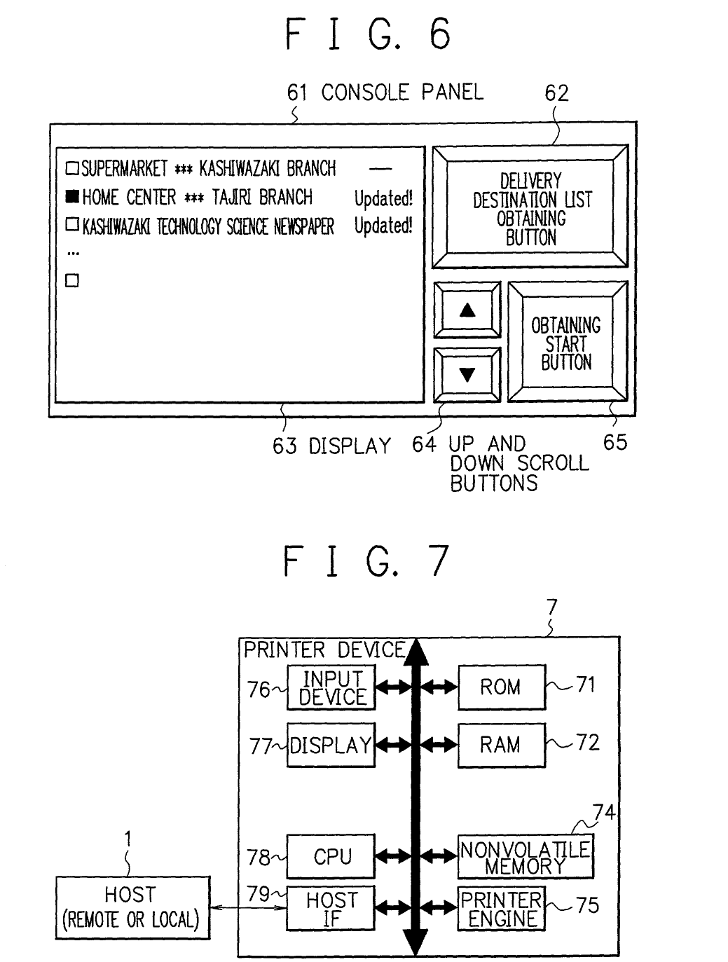

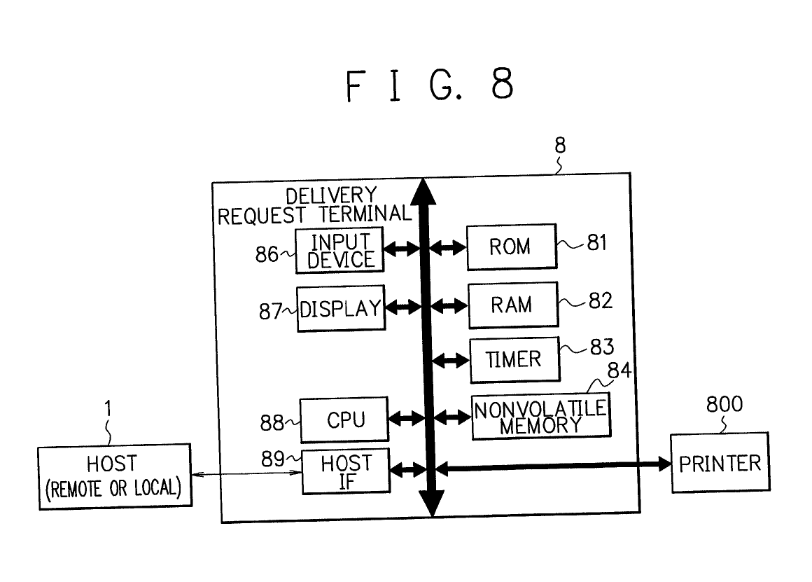

Now, a second embodiment of the present invention will be described with reference to FIGS. 6 and 7.

FIG. 7 shows a print system according to the second embodiment of the present invention.

In this embodiment, as shown in FIG. 7, the print system has a similar construction to that shown in FIG. 1, except that the timer 23 is taken out from the printer device, and an input device 76 is provided with a delivery request means (not shown). In this case, information can be obtained by a voluntary request of the user, which is different from the first embodiment in which information printing is automatically carried out by time control.

When a delivery request is inputted to a printer device 7 by the delivery request means of the input device 76, the printer device 7 connects to the host 1 and obtains the necessary contents from the host 1 to print the contents by the printer engine 75.

A delivery request for obtaining selected contents using the delivery request means will be described in detail with reference to FIG. 6.

In FIG. 6, an example of a console panel 61 having the input device 76 and a display 77 shown in FIG. 7 is shown. The console panel 61 includes a display 63, a delivery destination list obtaining button 62 constituting the input device 76, a pair of up and down scroll buttons 64 for scrolling the content of the display 63, and an obtaining start button 65.

In this case, a contents list provided by the host 1 is already displayed on the display 63. When the user operates the delivery destination list obtaining button 62, the contents of the display 63 is updated, and the updated contents are indicated by “Updated!”. The delivery request of the information can be made by moving a cursor (not shown) to the desired contents using the up and down scroll buttons 64 and operating the obtaining start button 65 to select the desired contents.

In this embodiment, the console panel 61 is used, but of course, a PC connected to the printer device 7 can be used also. That is, an application for carrying out the above-described settings while looking at the screen of the PC, sending the setting particulars to the printer device 7 and storing the setting particulars in a nonvolatile memory 74, can be prepared and used on the PC.

In this embodiment, communications between the printer device 7 and the host 1, and the accounting process can be conducted in the same manner as in the first embodiment following the flow charts shown in FIGS. 2 and 4.

Furthermore, the delivery request means as provided in the second embodiment can be employed in the first embodiment. In this case, besides the automatic printing by time control, the user can make voluntary delivery request of contents by using the delivery request means.

Now a third embodiment of the present invention will be described with reference to FIG. 8 showing a print system according to the third embodiment of the present invention.

In this embodiment, a delivery request terminal 8 is provided additionally. The delivery request terminal 8 has a similar construction as the printer device 2 of the first embodiment shown in FIG. 1, except that the printer engine is separated. In this embodiment, it is assumed that the user has a conventional type of printer 800 that does not have the function of the printer device 2 of the present invention.

Hence, the delivery request terminal 8 is arranged between the host 1 and the printer 800, and the combination of the delivery request terminal 8 and the printer 800 can provide substantially the same function of the printer device 2 of the present invention.

In this embodiment, communications between the delivery request terminal 8 and the host 1, and the accounting process can be performed in the same manner as in the first embodiment following the flow charts shown in FIGS. 2 and 4.

In the print system of the present invention, a color ink-jet printer, a color laser printer, a monochrome laser printer, a dot impact printer capable of using copying paper, etc. can be applied as the printer device.

As described above, in the print system of the present invention, when the predetermined time comes, the printer device voluntarily carries out the connection with the host to obtain prescribed contents from the host and prints out the obtained contents. Hence, a series of manual operations such as booting a host PC, searching the desired home page and printing out the obtained contents can be omitted and the load of the operator can be reduced. Furthermore, the host PC for giving print instructions becomes unnecessary.

In the print system of the present invention, the user selects particular contents, and therefore it can be considered that the user's interest toward the contents is very high. Hence, the contents provider can advertise not for unspecified number of people but for specified individuals, and a considerably large advertisement effect can be obtained.

According to the present invention, the contents provider side can learn the users' preference tendency on the basis of the printer IDs and the content IDs and can exploit it for marketing.

In the present invention, each printer device has a specific printer ID and the contents provider can control the contents on the basis of the printer ID.

In the present invention, the contents provider can provide charged and free information by discriminating the contents on the basis of the content IDs.

Further, according to the present invention, each printer device has the specific printer ID, but even if a third person obtains the printer ID, the third person cannot rewrite the printer ID of his/her own printer device. As a result, damages due to illegal use of the printer ID are not possible, and thus countermeasures against invalid use of printer ID is unnecessary.

In the present invention, the contents provider controls the contents delivery on the basis of the printer ID, and thus duplication of contents such as printing contents by plural printer devices can be prevented.

In the present invention, the contents provider can grasp the printer ID and the history or past records of the obtained contents information, and can provide the contents which can be printed only once or for a limited number of times for the printer device having the subject printer ID. Hence, the contents provider providing pay contents can effectively prevent invalid duplication of contents.

According to the present invention, the contents provider can obtain information about conditions of the connected printer devices from the delivery request information table in addition to the printer IDs. Hence, the contents provider can provide information or advice to the users about maintenance, upgrading, ink and toner cartridges exchanges and the like depending on the condition of the printer devices.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A print system comprising a printer device and a host which is connected to the printer device and provides contents to the printer device,
the printer device provided with a printer identification, including a nonvolatile memory holding a delivery request information table storing access destination addresses and specific information about the printer device including the printer identification, executing a delivery request of the contents to the host by sending the delivery request information table to the host, and receiving print data of the contents from the host to print the print data,
the host receiving the delivery request information table from the printer device, determining whether the requested contents should be delivered according to the printer identification included in the received delivery request information table, producing the print data of the contents on the basis of the specific information about the printer device, and delivering the print data to the printer device.

2. The print system of claim 1, wherein the printer device further includes a timer and the delivery request information table further stores an access time and an access period, and when the timer clocks the access time and the access period stored in the delivery request information table, the printer device accesses the access destination address and requests the host to deliver the contents.

3. The print system of claim 1, wherein the printer device further includes a delivery request means, and when the delivery request means inputs the delivery request, the printer device accesses the access destination address and requests the host to deliver the contents.

4. The print system of claim 2, wherein the printer device further includes a delivery request means, and when the delivery request means inputs the delivery request, the printer device accesses the access destination address and requests the host to deliver the contents.

5. The print system of claim 1, wherein the host obtains the specific information about the printer device from the delivery request information table and delivers the contents according to the specific information to either the printer device or a delivery request terminal.

6. The print system of claim 2, wherein the host obtains the specific information about the printer device from the delivery request information table and delivers the contents according to the specific information to either the printer device or a delivery request terminal.

7. The print system of claim 3, wherein the host obtains the specific information about the printer device from the delivery request information table and delivers the contents according to the specific information to either the printer device or a delivery request terminal.

8. The print system of claim 1, wherein the host obtains information about a past record of the contents obtained by either the printer device or a delivery request terminal from the delivery request information table and controls either the printer device or the delivery request terminal so that the printer device can print the specified contents for a limited number of times.

9. The print system of claim 2, wherein the host obtains information about a past record of the contents obtained by either the printer device or a delivery request terminal from the delivery request information table and controls either the printer device or the delivery request terminal so that the printer device can print the specified contents for a limited number of times.

10. The print system of claim 3, wherein the host obtains information about a past record of the contents obtained by either the printer device or a delivery request terminal from the delivery request information table and controls either the printer device or the delivery request terminal so that the printer device can print the specified contents for a limited number of times.

11. The print system of claim 5, wherein the host obtains information about a past record of the contents obtained by either the printer device or the delivery request terminal from the delivery request information table and controls either the printer device or the delivery request terminal so that the printer device can print the specified contents for a limited number of times.

12. The print system of claim 1, wherein the host separately controls charged and free contents according to the printer identification or a delivery request terminal identification, and when the contents requested for delivery are charged, a user is charged under either the printer identification or the delivery request terminal identification.

13. The print system of claim 2, wherein the host separately controls charged and free contents according to the printer identification or a delivery request terminal identification, and when the contents requested for delivery are charged, a user is charged under either the printer identification or the delivery request terminal identification.

14. The print system of claim 3, wherein the host separately controls charged and free contents according to the printer identification or a delivery request terminal identification, and when the contents requested for delivery are charged, a user is charged under either the printer identification or the delivery request terminal identification.

15. The print system of claim 5, wherein the host separately controls charged and free contents according to the printer identification or a delivery request terminal identification, and when the contents requested for delivery are charged, a user is charged under either the printer identification or the delivery request terminal identification.

16. The print system of claim 8, wherein the host separately controls charged and free contents according to the printer identification or a delivery request terminal identification, and when the contents requested for delivery are charged, a user is charged under either the printer identification or the delivery request terminal identification.

17. The print system of claim 1, wherein the printer device is a color ink-jet printer, a color laser printer, a monochrome laser printer or a dot impact printer.

18. The print system of claim 2, wherein the printer device is a color ink-jet printer, a color laser printer, a monochrome laser printer or a dot impact printer.

19. The print system of claim 3, wherein the printer device is a color ink-jet printer, a color laser printer, a monochrome laser printer or a dot impact printer.

20. The print system of claim 5, wherein the printer device is a color ink-jet printer, a color laser printer, a monochrome laser printer or a dot impact printer.

21. The print system of claim 8, wherein the printer device is a color ink-jet printer, a color laser printer, a monochrome laser printer or a dot impact printer.

22. The print system of claim 12, wherein the printer device is a color ink-jet printer, a color laser printer, a monochrome laser printer or a dot impact printer.

23. A print system comprising a printer device, a host providing contents and a delivery request terminal connected in between the printer device and the host,
the delivery request terminal provided with a delivery request terminal identification, including a nonvolatile memory holding a delivery request information table storing access destination addresses, the delivery request terminal identification and specific information about the printer device, executing a delivery request of the contents to the host by sending the delivery request information table to the host, and receiving print data of the contents from the host to send the print data to the printer device,
the printer device printing the received print data,
the host receiving the delivery request information table from the delivery request terminal, determining whether the requested contents should be delivered according to the delivery request terminal identification included in the received delivery request information table, producing the print data of the contents on the basis of the specific information about the printer device, and delivering the print data to the delivery request terminal.

24. The print system of claim 23, wherein the delivery request terminal further includes a timer and the delivery request information table further stores an access time and an access period, and when the timer clocks the access time and the access period stored in the delivery request information table, the delivery request terminal accesses the access destination address and requests the host to deliver the contents.

25. The print system of claim 23, wherein the delivery request terminal further includes a delivery request means, and when the delivery request means inputs the delivery request, the delivery request terminal accesses the access destination address and requests the host to deliver the contents.

26. The print system of claim 24, wherein the delivery request terminal further includes a delivery request means, and when the delivery request means inputs the delivery request, the delivery request terminal accesses the access destination address and requests the host to deliver the contents.

27. The print system of claim 23, wherein the host obtains the specific information about the printer device from the delivery request information table and delivers the contents according to the specific information to either the printer device or the delivery request terminal.

28. The print system of claim 24, wherein the host obtains the specific information about the printer device from the delivery request information table and delivers the contents according to the specific information to either the printer device or the delivery request terminal.

29. The print system of claim 25, wherein the host obtains the specific information about the printer device from the delivery request information table and delivers the contents according to the specific information to either the printer device or the delivery request terminal.

30. The print system of claim 23, wherein the host obtains information about a past record of the contents obtained by either the printer device or the delivery request terminal from the delivery request information table and controls either the printer device or the delivery request terminal so that the printer device can print the specified contents for a limited number of times.

31. The print system of claim 24, wherein the host obtains information about a past record of the contents obtained by either the printer device or the delivery request terminal from the delivery request information table and controls either the printer device or the delivery request terminal so that the printer device can print the specified contents for a limited number of times.

32. The print system of claim 25, wherein the host obtains information about a past record of the contents obtained by either the printer device or the delivery request terminal from the delivery request information table and controls either the printer device or the delivery request terminal so that the printer device can print the specified contents for a limited number of times.

33. The print system of claim 27, wherein the host obtains information about a past record of the contents obtained by either the printer device or the delivery request terminal from the delivery request information table and controls either the printer device or the delivery request terminal so that the printer device can print the specified contents for a limited number of times.

34. The print system of claim 23, wherein the host separately controls charged and free contents according to the printer identification or the delivery request terminal identification, and when the contents requested for delivery are charged, a user is charged under either the printer identification or the delivery request terminal identification.

35. The print system of claim 24, wherein the host separately controls charged and free contents according to the printer identification or the delivery request terminal identification, and when the contents requested for delivery are charged, a user is charged under either the printer identification or the delivery request terminal identification.

36. The print system of claim 25, wherein the host separately controls charged and free contents according to the printer identification or the delivery request terminal identification, and when the contents requested for delivery are charged, a user is charged under either the printer identification or the delivery request terminal identification.

37. The print system of claim 27, wherein the host separately controls charged and free contents according to the printer identification or the delivery request terminal identification, and when the contents requested for delivery are charged, a user is charged under either the printer identification or the delivery request terminal identification.

38. The print system of claim 30, wherein the host separately controls charged and free contents according to the printer identification or the delivery request terminal identification, and when the contents requested for delivery are charged, a user is charged under either the printer identification or the delivery request terminal identification.

39. The print system of claim 23, wherein the printer device is a color ink-jet printer, a color laser printer, a monochrome laser printer or a dot impact printer.

40. The print system of claim 24, wherein the printer device is a color ink jet printer, a color laser printer, a monochrome laser printer or a dot impact printer.

41. The print system of claim 25, wherein the printer device is a color ink-jet printer, a color laser printer, a monochrome laser printer or a dot impact printer.

42. The print system of claim 27, wherein the printer device is a color ink-jet printer, a color laser printer, a monochrome laser printer or a dot impact printer.

43. The print system of claim 30, wherein the printer device is a color ink-jet printer, a color laser printer, a monochrome laser printer or a dot impact printer.

44. The print system of claim 34, wherein the printer device is a color ink-jet printer, a color laser printer, a monochrome laser printer or a dot impact printer.
